(19) United States
(12) Patent Application Publication
(10) Pub. No.: US 2022/0183282 A1
(43) Pub. Date: Jun. 16, 2022

(54) Fatty Acid Derivatives For Improving The Effect Of Agrochemical Actives

(71) Applicant: Clariant International Ltd., Muttenz (CH)

(72) Inventors: Peter BAUR, Schondorf (DE); Luciana BODELON, Frankfurt am Main (DE); Javier CAMPOS CUEVAS, Bad Soden (DE); Martin BAUER, Eppstein (DE); Stephanie GIESSLER-GEISS, Frankfurt am Main (DE); Felix HÖVELMANN, Mühldorf (DE)

(73) Assignee: Clariant International Ltd., Muttenz (CH)

(21) Appl. No.: 17/433,534

(22) PCT Filed: Feb. 14, 2020
(86) PCT No.: PCT/EP2020/053885

§ 371 Date: Aug. 24, 2021

(30) Foreign Application Priority Data
Feb. 25, 2019 (EP) 19159036.3

(51) Int. Cl. A01N 25/30

(52) U.S. Cl. CPC A01N 25/30

(57) ABSTRACT

The use of one or more fatty acid derivatives of the formula (I) wherein R¹ is an alkyl group containing 5 to 17 carbon N atoms, which is linear or branched R², R³ are, independently, hydrogen, methyl, ethyl or hydroxymethyl with the proviso that one of R² and R³ is hydrogen and the other is different from hydrogen m, n are numbers from 0 to 17, with the proviso that m+n≥1, and m+n+p<18 where the different monomers can be arranged in statistical order, alternatingly or as a block copolymer; R⁴ is hydrogen or an alkyl group containing 1 to 10 carbon atoms, which is linear or branched, can improve wettability, retention and/or the uptake of agrochemical actives in and on target organisms, wherein the agrochemical actives are different from the fatty acid derivatives of formula (I).

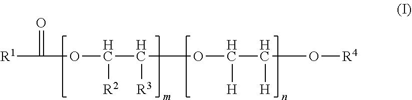

The invention relates to the use of specific fatty acid derivatives for improving the effect of agrochemical actives in and on plants and their use as adjuvants in agrochemical compositions. The invention also relates to agrochemical compostions, which comprise the fatty acid derivatives.

Agrochemical actives, mainly fungicides, herbicides and insecticides, are chemical or natural substances which penetrate into plant cells, plant tissue or parasitic organisms in or on the plant and damage and/or destroy them. Herbicides account for most of such active ingredients. They are usually employed in the form of agro-chemical compositions (formulations).

The biological activity of agrochemical actives can be determined by reference to the plant growth or the damage caused to the plants by the action of the agrochemical active on the leaf or via the roots as a function of the exposure time and the exposure concentration.

A general problem is that only a fraction of the agrochemical active displays the desired activity. The vast majority is lost without being utilized, due to the fact that the active substance, upon application of the spray mixture, does not reach the plant's leaves or roots and, unused, seeps into the soil, is washed off by rain or is not taken up by the plant.

This ecological and economical disadvantage can be reduced by adding adjuvants to agrochemical composition. These adjuvants can, for example, improve the wetting of the plant or ensure that the active substance adheres longer to the plant surface, or is taken up better. The nature and the amount of the adjuvants used often have a decisive effect on the activity of the agrochemical compositions.

The use of certain fatty acid derivatives in agrochemical compositions is known and described, e.g. in EP 2 446 743 A1, U.S. Pat. No. 6,068,849, US-A 2016/010227, JP 06279804 A, JP 08157819 A, U.S. Pat. No. 4,975,113 and JP 2018-100261.

Even though good results are already achieved with the known systems, there is still a need, for technical, economic and ecological reasons, to find suitable adjuvants which, under practical conditions, effectively increase the performance of agrochemical composition under various aspects.

It has now been found that specific fatty acid derivatives are particularly suitable for improving wettability and/or retention and/or the foliar uptake of agrochemical actives in and on plants.

Accordingly, in one aspect the invention provides the use of one or more fatty acid derivatives of the formula (I)

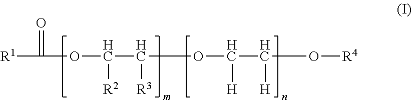

wherein
R¹ is an alkyl group containing 5 to 17 carbon atoms, which is linear or branched
R², R³ are, independently, hydrogen, methyl, ethyl or hydroxymethyl with the proviso that one of R² and R³ is hydrogen and the other is dofferent from hydrogen
m, n are numbers from 0 to 17, with the proviso that m+n≥1, and m+n+p<18 where
   the different monomers can be arranged in statistical order, alternatingly or as a block copolymer;
R⁴ is hydrogen or an alkyl group containing 1 to 10 carbon for improving wettability, retention and/or the uptake of agrochemical actives in and on target organisms, wherein the agrochemical actives are different from the fatty acid drivatives of formula (I).

Some of the fatty acids of formula (I) are new as adjuvants in agrochemical compositions comprising agrochemical actives.

Accordingly, in a further aspect the invention provides the use of one or more fatty acid derivatives of the formula (Ia),

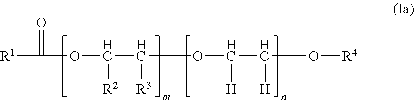

wherein
R¹ is an alkyl group containing 5 to 13 carbon atoms, which is linear or branched;
R², R³ are, independently, hydrogen, methyl, ethyl or hydroxymethyl;
m, n are numbers from 0 to 12, with the proviso that m+n>4, and m+n<12 where
   the different monomers can be arranged in statistical order, alternatingly or as a block copolymer,
R⁴ is a methyl group
   as an adjuvant for improving the effect of active agrochemical ingredients, wherein the agrochemical actives are different from the fatty acid drivatives of form ual (I).

An “adjuvant” as used herein is a component which improves the biological effect of agrochemical actives without having—at the concentration it is used—a biological effect. Adjuvants may, inter alia, improve wettability, retention and/or the foliar uptake of agrochemical actives in and on plants.

The term “agrochemical active” as used herein generally means agrochemically active compounds which are different from the fatty acid derivatives of the formula (I) and (Ia).

In a further aspect the invention provides an agrochemical composition which is an agrochemical concentrate comprising at least one agrochemical active ingredient, which is different from the fatty acid derivatives of the formula (I), and one or more fatty acid derivatives of the formula (Ia) as an adjuvant, where the concentration of the one or more fatty acid derivatives of the formula (Ia) is of from 0.001 to 99% by weight, preferably 0.1 to 50% by weight, more preferably 1 to 20% by weight, based on the whole spray liquid.

In yet a further aspect of the invention provides an agrochemical composition which is a spray liquid comprisingat least one agrochemical active ingredient, which is different from the fatty acid derivatives of th formula (I) in claim 1, and one or more fatty acid derivatives of the formula (Ia), where the concentration of the one or more fatty acid derivatives of the formula (Ia) is of from 0.0001 to 1% by weight, preferably 0.001 to 0.5% by weight, more preferably 0.01 to 0.2% by weight, in particular 0.03 to 0.1% by weight, based on the whole spray liquid.

In a further aspect the invention provides a method for improving the effect of an agrochemical active, which is different from the fatty acid derivatives of the formula (Ia), in and on plants comprising the step of adding to the active agrochemical ingredient one or more fatty acid derivatives of the formula (I).

With the above-described fatty acid derivatives of the formula (I), it is possible to produce active ingredient compositions of the invention having excellent performance properties.

The fatty acid derivatives of the invention promote not only the wetting and retention of agrochemical actives to the plant, particularly to the leaves, but also the penetration of agrochemical inactives contained in crop protection products into the plant. This improvement of the properties is achieved even at low concentrations of fatty acid derivatives of the invention.

In a preferred embodiment of the invention the fatty derivatives of formula (I) are fatty acid derivatives of the formula (Ia), i.e., the symbols and indices in formula (I) have the meaning of the corresponding symbols and indices in formula (Ia).

In further preferred embodiments the symbols and indices in formulae (I) and (Ia) have the following meanings:
R¹ is preferably a linear alkyl group.
R¹ is preferably an alkyl group with 5 to 11, preferably 7 to 9, carbon atoms, which is preferably linear.
R², R³ are preferably hydrogen, methyl or ethyl, more preferably hydrogen or methyl.
m is preferably a number from 0 to 5.

In a preferred embodiment m is 0.

In a further embodiment is a number from 1 to 5.

n is preferably a number from 0 to <12.

If m is 0, n is a number from >4, preferably ≥5, more preferably >5 to <12, preferably <9, more preferably ≤7.

m+n is preferably >4, more preferably ≥5 and <12, preferably <9, more preferably ≤7.

The term “number” as used herein means 0 or a positive rational number. m and n are statistical values, therefore the monomer units m and n can be statistical mixtures.

Further preferred are fatty acid derivatives of formulae (I) and (Ia), where
R¹ is a linear alkyl group with 7 to 9 carbon atoms;
m is 0;
n is a number from >4, preferably 5 to 9, preferably 7, and
R⁴ is a methyl group.

Particularly preferred are the fatty acid derivates of formulae (I) and (Ia) specified as A1 and A2 in the examples.

The fatty acid derivatives of the formula (I) can be prepared by methods know to those skilled in the art, as described e.g. in U.S. Pat. No. 7,595,291 B2 (BASF SE, Esterified alkyl alkoxylates used as low-foam surfactants). The compounds are usually prepared by condensation of fatty acid or fatty acid ester and the respective alcohol alkoxylate by removal of water or the alcohol, respectively, in the presence of an acidic catalyst. Alcohol alkoxylate derivatives are prepared by reacting a suitable precursor, e.g. an alcohol or and alkoxylated alcohol, with an alkylene oxide in the presence of an alkoxylation catalyst. Among others, NaOMe, KOMe, NaOH, KOH, alkaline earth-based catalysts or double metal cyanide (DMC) catalysts can be used (e.g. SHELL OIL COMPANY-US2012/310004, 2012, A1 Nonyl alcohols with a low degree of branching and their derivatives). The composition of the alkyene oxide chain can be either a single pure alkylene oxide, preferably selected from the group of ethylene oxide, propylene oxide or butylene oxide, or a copolymer of a binary or ternary mixture of alkylene oxides. The copolymers may be arranged in a statistical distribution, alternatingly, as block copolymers or a mixture thereof.

Compounds of comparable chemical compositions can be realized by reacting a carboxylic acid ester with one or more alkylene oxides in the presence of a suitable insertion catalyst. The ester is preferably, but not exclusively,a methyl ester. Specific procedures are disclosed, e.g., in Scholz H. J., StUhler H., Quack J., Schuler W., Trautmann, M. (1988) Verfahrung zur Herstellung von Carbonsäaureestern von Alkylenglykolethern and deren Verwendung, D E 3810793A1 (Hoechst), Weerasooriya U, Robertson D T, Lin J, Leach B E, Aeschbacher C L, Sandoval T S (1995) Process for alkoxylation of esters and products produced therefrom, U.S. Pat. No. 5,386,045, and Tanaka T, Imamaka T, Kaeaguchi T, Nagumo H (1997) Process for producing ester alkoxide compound and surfactant comprising ester alkoxylate compound, EP0783012.

Use can be further made of the detailed instructions in the examples section which describe in detail how to prepare these and any further compounds of the invention.

The one or more fatty acid derivatives of the formula (I) can be used in the production of agrochemical compositions. The result here is compositions used in accordance with the invention that comprise one or more fatty acid derivatives of the formula (I) and one or more agrochemical actives.

“Agrochemical compositions” in the context of the invention are understood to mean compositions comprising one or more agrochemical actives (being different from the fatty acid derivatives of the invention) and one or more fatty acid derivatives of the formula (I). The agrochemical actives especially include pesticides, phytohormones, preferably growth regulators, biological pesticides, salts deployable in water, preferably fertilizers or plant nutrients or fungicidal copper compounds, and repellents.

In a preferred embodiment of the invention, the one or more fatty acid derivatives of the formula (I) are in the form of a tankmix additive, meaning that the one or more fatty acid derivatives of the formula (I) are only added to a spray liquid produced from an agrochemical concentrate directly prior to deployment.

In another preferred embodiment of the invention, the one or more fatty acid derivatives of the formula (I) are in the form of an in-can variant, meaning that the one or more fatty acid derivatives of the formula (I) have already been incorporated into an agrochemical concentrate together with the agrochemical active(s) and optionally further ingredients of the agrochemical concentrate, and are deployed as a spray liquid after dilution with water.

Where the fatty acid derivatives of formula (I) or (Ia) are employed in the form of an agrochemical concentrate, it is generally in a concentration of from 0.001 to 99% by weight, preferably 0.1 to 50% by weight, more preferably 1 to 20% by weight, based on the whole agrochemical concentrate.

The one or more fatty acid derivatives of the formula (I) are preferably used in ready-to-use agrochemical compositions in the form of spray liquids, in which case the amount of the one or more fatty acid derivatives of the formula (I) in the spray liquid is preferably from 0.0001% to 1% by weight, more preferably from 0.001% to 0.5% by weight, especially preferably from 0.01% to 0.2% by weight and exceptionnally preferably from 0.03% to 0.1% by weight, based in each case on the total weight of the spray liquid. Accordingly, the term agrochemical composition encompasses agrochemical concentrates as well as spray liquids.

If an active ingredient composition comprises two or more fatty acid derivatives of the formula (I), the stated amount is understood to mean the total content of all fatty acid derivatives of the formula (I).

The agrochemical actives present in the agrochemical compositions of the invention may be a single agrochemical active or a mixture of two or more agrochemical actives. The agrochemical actives may generally be any active substance used in agrochemical compositions, for example in crop treatment compositions, with which a desired effect can be achieved in the species treated, for example plants.

Preferably, the agrochemical actives are one or more pesticides.

“Pesticides” are understood in the context of the present invention to mean herbicides, fungicides, insecticides, acaricides, bactericides, molluscicides, nematicides, plant growth regulators and rodenticides. An overview of the most relevant pesticides can be found, for example, in “The Pesticide Manual” from the British Crop Protection Council, 18th Edition 2018, editor: Dr. J. A. Turner. Explicit reference is hereby made to the active ingredients listed therein. They are incorporated into this description by reference.

Examples of herbicides include:

acetochlor, acibenzolar, acibenzolar-S-methyl, acifluorfen, acifluorfen-sodium, aclonifen, alachlor, allidochlor, alloxydim, alloxydim-sodium, ametryne, amicarbazone, amidochlor, amidosulfuron, aminocyclopyrachlor, aminocyclopyrachlor-potassium, aminocyclopyrachlor-methyl, aminopyralid, amitrole, ammonium sulfamate, ancym idol, anilofos, asulam, atrazine, aviglycine, azafenidin, azimsulfuron, aziprotryne, beflubutamid, benazolin, benazolin-ethyl, bencarbazone, benfluralin, benfuresate, bensulide, bensulfuron, bensulfuron-methyl, bentazone, benzfendizone, benzobicyclon, benzofenap, benzofluor, benzoylprop, benzyladenine, bicyclopyrone, bifenox, bilanafos, bilanafos-sodium, bispyribac, bispyribac-sodium, bromacil, bromobutide, bromofenoxim, bromoxynil, bromuron, buminafos, busoxinone, butachlor, butafenacil, butamifos, butenachlor, butralin, butroxydim, butylate, cafenstrole, carbaryl, carbetamide, carfentrazone, carfentrazone-ethyl, carvone, chlorocholine chloride, chlomethoxyfen, chloramben, chlorazifop, chlorazifop-butyl, chlorbromuron, chlorbufam, chlorfenac, chlorfenac-sodium, chlorfenprop, chlorflurenol, chlorflurenol-methyl, chloridazon, chlorimuron, chlorimuron-ethyl, chlormequat-chloride, chlornitrofen, 4-chlorophenoxyacetic acid, chlorophthalim, chlorpropham, chlorthal-dimethyl, chlortoluron, chlorsulfuron, cinidon, cinidon-ethyl, cinmethylin, cinosulfuron, clethodim, clodinafop, clodinafop-propargyl, clofencet, clomazone, clomeprop, cloprop, clopyralid, cloransulam, cloransulam-methyl, cloxyfonac, cumyluron, cyanamide, cyanazine, cyclanilide, cycloate, cyclosulfamuron, cycloxydim, cycluron, cyhalofop, cyhalofop-butyl, cyperquat, cyprazine, cyprazole, cytokinine, 2,4-D, 2,4-DB, daimuron/dymron, dalapon, daminozide, dazomet, n-decanol, desmedipham, desmetryn, detosyl-pyrazolate (DTP), diallate, diaminozide, dicamba, dichlobenil, dichlorprop, dichlorprop-P, diclofop, diclofop-methyl, diclofop-P-methyl, diclosulam, diethatyl, diethatyl-ethyl, difenoxuron, difenzoquat, diflufenican, diflufenzopyr, diflufenzopyr-sodium, dikegulac-sodium, dimefuron, dimepiperate, dimethachlor, dimethametryn, dimethenamid, dimethenamid-P, dimethipin, dimetrasulfuron, dinitramine, dinoseb, dinoterb, diphenam id, diisopropylnaphthalene, dipropetryn, diquat, diquat-dibromide, dithiopyr, diuron, DNOC, eglinazine-ethyl, endothal, EPTC, esprocarb, ethalfluralin, ethametsulfuron, ethametsulfuron-methyl, ethyl naphthylacetate, ethephon, ethidimuron, ethiozin, ethofumesate, ethoxyfen, ethoxyfen-ethyl, ethoxysulfuron, etobenzanid, F-5331, i.e. N-[2-chloro-4-fluoro-5-[4-(3-fluoropropyl)-4,5-dihydro-5-oxo-1H-tetrazol-1-yl]phenyl]ethanesulfonamide, F-7967, i.e. 3-[7-chloro-5-fluoro-2-(trifluoromethyl)-1H-benzimidazol-4-yl]-1-methyl-6-(trifluoromethyl)pyrimidine-2,4(1H,3H)-dione, fenoprop, fenoxaprop, fenoxaprop-P, fenoxaprop-ethyl, fenoxaprop-P-ethyl, fenoxasulfone, fentrazamide, fenuron, flamprop, flamprop-M-isopropyl, flamprop-M-methyl, flazasulfuron, florasulam, fluazifop, fluazifop-P, fluazifop-butyl, fluazifop-P-butyl, fluazolate, flucarbazone, flucarbazone-sodium, flucetosulfuron, fluchloralin, flufenacet (thiafluamide), flufenpyr, flufenpyr-ethyl, flumetralin, flumetsulam, flumiclorac, flumiclorac-pentyl, flumioxazin, flumipropyn, fluometuron, fluorodifen, fluoroglycofen, fluoroglycofen-ethyl, flupoxam, flupropacil, flupropanate, flupyrsulfuron, flupyrsulfuron-methyl-sodium, flurenol, flurenol-butyl, fluridone, flurochloridone, fluroxypyr, fluroxypyr-meptyl, flurprimidol, flurtamone, fluthiacet, fluthiacet-methyl, fluthiamide, fomesafen, foramsulfuron, forchlorfenuron, fosamine, furyloxyfen, gibberellic acid, glufosinate, glufosinate-ammonium, glufosinate-P, glufosinate-P-ammonium, glufosinate-P-sodium, glyphosate, glyphosate-isopropylammonium, H-9201, i.e. O-(2,4-dimethyl-6-nitrophenyl) O-ethyl isopropylphosphoramidothioate, halosafen, halosulfuron, halosulfuron-methyl, haloxyfop, haloxyfop-P, haloxyfop-ethoxyethyl, haloxyfop-P-ethoxyethyl, haloxyfop-methyl, haloxyfop-P-methyl, hexazinone, HW-02, i.e. 1-(dimethoxyphosphoryl)ethyl (2,4-dichlorophenoxy)acetate, imazamethabenz, imazamethabenz-methyl, imazamox, imazamox-ammonium, imazapic, imazapyr, imazapyr-isopropylammonium, imazaquin, imazaquin-ammonium, imazethapyr, imazethapyr-ammonium, imazosulfuron, inabenfide, indanofan, indaziflam, indoleacetic acid (IAA), 4-indol-3-ylbutyric acid (IBA), iodosulfuron, iodosulfuron-methyl-sodium, iofensulfuron, iofensulfuron-sodium, ioxynil, ipfencarbazone, isocarbamid, isopropalin, isoproturon, isouron, isoxaben, isoxachlortole, isoxaflutole, isoxapyrifop, KUH-043, i.e. 3-({[5-(difluoromethyl)-1-methyl-3-(trifluoromethyl)-1H-pyrazol-4-yl]methyl}sulfonyl)-5,5-dimethyl-4,5-dihydro-1,2-oxazole, karbutilate, ketospiradox, lactofen, lenacil, linuron, maleic hydrazide, MCPA, MCPB, MCPB-methyl, -ethyl and -sodium, mecoprop, mecoprop-sodium, mecoprop-butotyl, mecoprop-P-butotyl, mecoprop-P-dimethylammonium, mecoprop-P-2-ethylhexyl, mecoprop-P-potassium, mefenacet, mefluidide, mepiquat-chloride, mesosulfuron, mesosulfuron-methyl, mesotrione, methabenzthiazuron, metam, metamifop, metamitron, metazachlor, metazasulfuron, methazole, methiopyrsulfuron, methiozolin, methoxyphenone, methyldymron, 1-methylcyclopropene, methyl isothiocyanate, metobenzuron, metobromuron, metolachlor, S-metolachlor, metosulam, metoxuron, metribuzin, metsulfuron, metsulfuron-methyl, molinate, monalide, monocarbamide, monocarbamide dihydrogensulfate, monolinuron, monosulfuron, monosulfuron ester, monuron, MT-128, i.e. 6-chloro-N-[(2E)-3-chloroprop-2-en-1-yl]-5-methyl-N-phenylpyridazin-3-amine, MT-5950, i.e. N-[3-chloro-4-(1-methylethyl)phenyl]-2-methylpentanamide, NGGC-011, 1-naphthylacetic acid (NAA), naphthylacetamide (NAAm), 2-naphthoxyacetic acid, naproanilide, napropamide, naptalam, NC-310, i.e. 4-(2,4-dichlorobenzoyl)-1-methyl-5-benzyloxypyrazole, neburon, nicosulfuron, nipyraclofen, nitralin, nitrofen, nitroguaiacolate, nitrophenolate-sodium (isomer mixture), nitrofluorfen, nonanoic acid, norflurazon, orbencarb, orthosulfamuron, oryzalin, oxadiargyl, oxadiazon, oxasulfuron, oxaziclomefone, oxyfluorfen, paclobutrazole, paraquat, paraquat dichloride, pelargonic acid (nonanoic acid), pendimethalin, pendralin, penoxsulam, pentanochlor, pentoxazone, perfluidone, pethoxamid, phenisopham, phenmedipham, phenmedipham-ethyl, picloram, picolinafen, pinoxaden, piperophos, pirifenop, pirifenop-butyl, pretilachlor, primisulfuron, primisulfuron-methyl, probenazole, profluazole, procyazine, prodiamine, prifluraline, profoxydim, prohexadione, prohexadione-calcium, prohydrojasmone, prometon, prometryn, propachlor, propanil, propaquizafop, propazine, propham, propisochlor, propoxycarbazone, propoxycarbazone-sodium, propyrisulfuron, propyzamide, prosulfalin, prosulfocarb, prosulfuron, prynachlor, pyraclonil, pyraflufen, pyraflufen-ethyl, pyrasulfotole, pyrazolynate (pyrazolate), pyrazosulfuron, pyrazosulfuron-ethyl, pyrazoxyfen, pyribambenz, pyribambenz-isopropyl, pyribambenz-propyl, pyribenzoxim, pyributicarb, pyridafol, pyridate, pyriftalid, pyriminobac, pyriminobac-methyl, pyrimisulfan, pyrithiobac, pyrithiobac-sodium, pyroxasulfone, pyroxsulam, quinclorac, quinmerac, quinoclamine, quizalofop, quizalofop-ethyl, quizalofop-P, quizalofop-P-ethyl, quizalofop-P-tefuryl, rimsulfuron, saflufenacil, secbumeton, sethoxydim, siduron, simazine, simetryn, SN-106279, i.e. methyl (2R)-2-({7-[2-chloro-4-(trifluoromethyl)phenoxy]-2-naphthyl}oxy)propanoate, sulcotrione, sulfallate (CDEC), sulfentrazone, sulfometuron, sulfometuron-methyl, sulfosate (glyphosate-trimesium), sulfosulfuron, SW-065, SYN-523, SYP-249, i.e. 1-ethoxy-3-methyl-1-oxobut-3-en-2-yl 5-[2-chloro-4-(trifluoromethyl)phenoxy]-2-nitrobenzoate, SYP-300, i.e. 1-[7-fluoro-3-oxo-4-(prop-2-yn-1-yl)-3,4-dihydro-2H-1,4-benzoxazin-6-yl]-3-propyl-2-thioxoimidazolidine-4,5-dione, tebutam, tebuthiuron, tecnazene, tefuryltrione, tembotrione, tepraloxydim, terbacil, terbucarb, terbuchlor, terbumeton, terbuthylazine, terbutryne, thenylchlor, thiafluamide, thiazafluron, thiazopyr, thidiazimin, thidiazuron, thiencarbazone, thiencarbazone-methyl, thifensulfuron, thifensulfuron-methyl, thiobencarb, tiocarbazil, topramezone, tralkoxydim, triafamone, triallate, triasulfuron, triaziflam, triazofenamide, tribenuron, tribenuron-methyl, tribufos, trichloroacetic acid (TCA), triclopyr, tridiphane, trietazine, trifloxysulfuron, trifloxysulfuron-sodium, trifluralin, triflusulfuron, triflusulfuron-methyl, trimeturon, trinexapac, trinexapac-ethyl, tritosulfuron, tsitodef, uniconazole, uniconazole-P, vernolate, ZJ-0862, i.e. 3,4-dichloro-N-{2-[(4,6-dimethoxypyrimidin-2-yl)oxy]benzyl}aniline, and the following compounds:

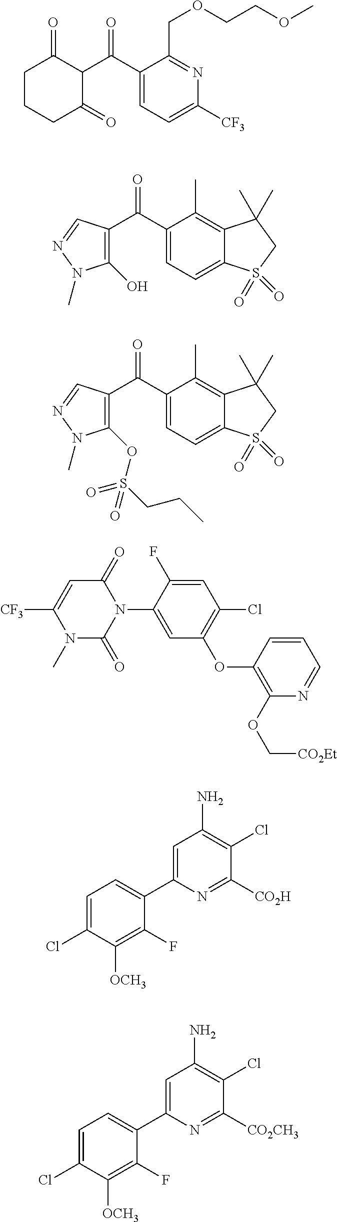

Phytohormones control physiological reactions, such as growth, flowering rhythm, cell division and seed ripening. Examples of growth regulators include natural and synthetic plant hormones such as abscisic acid, benzyladenine, caprylic acid, decanol, indoleacetic acid, jasmonic acid and esters thereof, salicylic acid and esters thereof, gibberellic acid, kinetin and brassinosteroids.

Examples of fungicides include:

(1) Ergosterol biosynthesis inhibitors, for example aldimorph, azaconazole, bitertanol, bromuconazole, cyproconazole, diclobutrazole, difenoconazole, diniconazole, diniconazole-M, dodemorph, dodemorphacetate, epoxiconazole, etaconazole, fenarimol, fenbuconazole, fenhexamid, fenpropidin, fenpropimorph, fluquinconazole, flurprimidol, flusilazole, flutriafol, furconazole, furconazole-cis, hexaconazole, imazalil, imazalil sulfate, imibenconazole, ipconazole, metconazole, myclobutanil, naftifin, nuarimol, oxpoconazole, paclobutrazole, pefurazoate, penconazole, piperalin, prochloraz, propiconazole, prothioconazole, pyributicarb, pyrifenox, quinconazole, simeconazole, spiroxamine, tebuconazole, terbinafine, tetraconazole, triadimefon, triadimenol, tridemorph, triflumizole, triforine, triticonazole, uniconazole, uniconazole-p, viniconazole, voriconazole, 1-(4-chlorophenyl)-2-(1H-1,2,4-triazol-1-yl)cycloheptanol, methyl 1-(2,2-dimethyl-2,3-dihydro-1H-inden-1-yl)-1H-imidazole-5-carboxylate, N′-{5-(difluoromethyl)-2-methyl-4-[3-(trimethylsilyl)propoxy]phenyl}-N-ethyl-N-methylimidoformamide, N-ethyl-N-methyl-N′-{2-methyl-5-(trifluoromethyl)-4-[3-(trimethylsilyl)propoxy]phenyl}imidoformamide and O-[1(4-(4-methoxyphenoxy)-3,3-dimethylbutan-2-yl] 1H-imidazole-1-carbothioate.

(2) Respiration inhibitors (respiratory chain inhibitors), for example bixafen, boscalid, carboxin, diflumetorim, fenfuram, fluopyram, flutolanil, fluxapyroxad, furametpyr, furmecyclox, isopyrazam (mixture of the syn-epimeric racemate 1RS,4SR,9RS and of the anti-epimeric racemate 1RS,4SR,9SR), isopyrazam (anti-epimeric racemate), isopyrazam (anti-epimeric enantiomer 1R,4S,9S), isopyrazam (anti-epimeric enantiomer 1S,4R,9R), isopyrazam (syn-epimeric racemate 1RS,4SR,9RS), isopyrazam (syn-epimeric enantiomer 1R,4S,9R), isopyrazam (syn-epimeric enantiomer 1S,4R,9S), mepronil, oxycarboxin, penflufen, penthiopyrad, sedaxane, thifluzamid, 1-methyl-N-[2-(1,1,2,2-tetrafluoroethoxy)phenyl]-3-(trifluoromethyl)-1H-pyrazole-4-carboxamide, 3-(difluoromethyl)-1-methyl-N[2-(1,1,2,2-tetrafluoroethoxy)phenyl]-1H-pyrazole-4-carboxamide, 3-(difluoromethyl)-N-[4-fluoro-2-(1,1,2,3,3,3-hexafluoropropoxy)phenyl]-1-methyl-1H-pyrazole-4-carboxamide, N-[1-(2,4-dichlorophenyl)-1-methoxypropan-2-yl]-3-(difluoromethyl)-1-methyl-1H-pyrazole-4-carboxamide, 5,8-difluoro-N-[2-(2-fluoro-4-{[4-(trifluoromethyl)pyridin-2-yl]oxy}phenyl)ethyl]quinazoline-4-amine, N-[9-(dichloromethylene)-1,2,3,4-tetrahydro-1,4-methanonaphthalen-5-yl]-3-(difluoromethyl)-1-methyl-1H-pyrazole-4-carboxamide, N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide and N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide.

(3) Respiration inhibitors (respiratory chain inhibitors) acting on complex III of the respiratory chain, for example ametoctradin, amisulbrom, azoxystrobin, cyazofamid, coumethoxystrobin, coumoxystrobin, dimoxystrobin, enestroburin, famoxadone, fenamidone, fenoxystrobin, fluoxastrobin, kresoxim-methyl, metominostrobin, orysastrobin, picoxystrobin, pyraclostrobin, pyrametostrobin, pyraoxystrobin, pyribencarb, triclopyricarb, trifloxystrobin, (2E)-2-(2-{[6-(3-chloro-2-methylphenoxy)-5-fluoropyrimidin-4-yl]oxy}phenyl)-2-(methoxyimino)-N-methylethanamide, (2E)-2-(methoxyimino)-N-methyl-2-(2-{[({(1E)-1-[3-(trifluoromethyl)phenyl]ethylidene}amino)oxy]methyl}pheny)ethanamide, (2E)-2-(methoxyimino)-N-methyl-2-{2-[(E)-({1-[3-(trifluoromethyl)phenyl]ethoxy}imino)methyl]phenyl}ethanamide, (2E)-2-{2-[({[(1E)-1-(3-{[(E)-1-fluoro-2-phenylethenyl]oxy}phenyl)ethylidene]amino}oxy)methyl]phenyl}-2-(methoxyimino)-N-methylethanamide, (2E)-2-{2-[({[(2E,3E)-4-(2,6-dichlorophenyl)but-3-en-2-ylidene]amino}oxy)methyl]phenyl}-2-(methoxyimino)-N-methylethanamide, 2-chloro-N-(1,1,3-trimethyl-2,3-dihydro-1H-inden-4-yl)pyridine-3-carboxamide, 5-methoxy-2-methyl-4-(2-{[({(1E)-1-[3-(trifluoromethyl)phenyl]ethylidene}amino)oxy]methyl}phenyl)-2,4-dihydro-3H-1,2,4-triazol-3-one, methyl (2E)-2-{2-[({cyclopropyl[(4-methoxyphenyl)imino]methyl}sulfanyl)methyl]phenyl}-3-methoxyprop-2-enoate, N-(3-ethyl-3,5,5-trimethylcyclohexyl)-3-(formylamino)-2-hydroxybenzamide, 2-{2-[(2,5-dimethylphenoxy)methyl]phenyl}-2-methoxy-N-methylacetamide and (2R)-2-{2-[(2,5-dimethylphenoxy)methyl]phenyl}-2-methoxy-N-methylacetamide.

(4) Mitosis and cell division inhibitors, for example benomyl, carbendazim, chlorfenazole, diethofencarb, ethaboxam, fluopicolide, fuberidazole, pencycuron, thiabendazole, thiophanate-methyl, thiophanate, zoxamide, 5-chloro-7-(4-methylpiperidin-1-yl)-6-(2,4,6-trifluorophenyl)[1,2,4]triazolo[1,5-a]pyrimidine and 3-chloro-5-(6-chloropyridin-3-yl)-6-methyl-4-(2,4,6-trifluorophenyl)pyridazine.

(5) Compounds with multisite activity, for example Bordeaux mixture, captafol, captan, chlorothalonil, copper preparations such as copper hydroxide, copper naphthenate, copper oxide, copper oxychloride, copper sulfate, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram zinc, oxine-copper, propamidine, propineb, sulfur and sulfur preparations, for example calcium polysulfide, thiram, tolylfluanid, zineb and ziram.

(6) Resistance inductors, for example acibenzolar-S-methyl, isotianil, probenazole and tiadinil.

(7) Amino acid and protein biosynthesis inhibitors, for example andoprim, blasticidin-S, cyprodinil, kasugamycin, kasugamycin hydrochloride hydrate, mepanipyrim, pyrimethanil and 3-(5-fluoro-3,3,4,4-tetramethyl-3,4-dihydroisoquinolin-1-yl)quinoline.

(8) Inhibitors of ATP production, for example fentin acetate, fentin chloride, fentin hydroxide and silthiofam.

(9) Cell wall synthesis inhibitors, for example benthiavalicarb, dimethomorph, flumorph, iprovalicarb, mandipropamid, polyoxins, polyoxorim, validamycin A and valifenalate.

(10) Lipid and membrane synthesis inhibitors, for example biphenyl, chloroneb, dicloran, edifenphos, etridiazole, iodocarb, iprobenfos, isoprothiolane, propamocarb, propamocarb hydrochloride, prothiocarb, pyrazophos, quintozene, tecnazene and tolclofos-methyl.

(11) Melanin biosynthesis inhibitors, for example carpropamid, diclocymet, fenoxanil, fthalide, pyroquilon, tricyclazole and 2,2,2-trifluoroethyl {3-methyl-1-[(4-methylbenzoyl)amino]butan-2-yl}carbamate.

(12) Nucleic acid synthesis inhibitors, for example benalaxyl, benalaxyl-M (kiralaxyl), bupirimate, clozylacon, dimethirimol, ethirimol, furalaxyl, hymexazol, metalaxyl, metalaxyl-M (mefenoxam), ofurace, oxadixyl and oxolinic acid.

(13) Signal transduction inhibitors, for example chlozolinate, fenpiclonil, fludioxonil, iprodione, procymidone, quinoxyfen and vinclozolin.

(14) Decouplers, for example binapacryl, dinocap, ferimzone, fluazinam and meptyldinocap.

(15) Further compounds, for example benthiazole, bethoxazin, capsimycin, carvone, chinomethionat, pyriofenone (chlazafenone), cufraneb, cyflufenamid, cymoxanil, cyprosulfamide, dazomet, debacarb, dichlorophen, diclomezine, difenzoquat, difenzoquat methylsulfate, diphenylamine, ecomat, fenpyrazamine, flumetover, fluoromide, flusulfamide, flutianil, fosetyl-aluminum, fosetyl-calcium, fosetyl-sodium, hexachlorobenzene, irumamycin, methasulfocarb, methyl isothiocyanate, metrafenon, mildiomycin, natamycin, nickel dimethyldithiocarbamate, nitrothal-isopropyl, octhilinone, oxamocarb, oxyfenthiin, pentachlorophenol and salts thereof, phenothrin, phosphoric acid and salts thereof, propamocarb-fosetylate, propanosine-sodium, proquinazid, pyrimorph, (2E)-3-(4-tert-butylphenyl)-3-(2-chloropyridin-4-yl)-1-(morpholin-4-yl)prop-2-en-1-one, (2Z)-3-(4-tert-butylphenyl)-3-(2-chloropyridin-4-yl)-1-(morpholin-4-yl)prop-2-en-1-one, pyrrolnitrin, tebufloquin, tecloftalam, tolnifanid, triazoxide, trichlamide, zarilamide, (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl2-methylpropanoate, 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-{4-[5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, 1-(4-methoxyphenoxy)-3,3-dimethylbutan-2-yl1H-imidazole-1-carboxylate, 2,3,5,6-tetrachloro-4-(methylsulfonyl)pyridine, 2,3-dibutyl-6-chlorothieno[2,3-d]pyrimidin-4(3H)-one, 2,6-dimethyl-1H,5H-[1,4]dithiino[2,3-c:5,6-c′]dipyrrole-1,3,5,7(2H,6H)-tetrone, 2-[5-methyl-3-(trifluoromethyl)-1H-pyrazol-1-yl]-1-(4-{4-[(5R)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-(4-{4-[(5S)-5-phenyl-4,5-dihydro-1,2-oxazol-3-yl]-1,3-thiazol-2-yl}piperidin-1-yl)ethanone, 2-[5-methyl-3-(trifluoromethyl)-1H-pyrazol-1-yl]-1-{4-[4-(5-phenyl-4,5-dihydro-1,2-oxazol-3-yl)-1,3-thiazol-2-yl]piperidin-1-yl}ethanone, 2-butoxy-6-iodo-3-propyl-4H-chromen-4-one, 2-chloro-5-[2-chloro-1-(2,6-difluoro-4-methoxyphenyl)-4-methyl-1H-imidazol-5-yl]pyridine, 2-phenylphenol and salts thereof, 3-(4,4,5-trifluoro-3,3-dimethyl-3,4-dihydroisoquinolin-1-yl)quinoline, 3,4,5-trichloropyridine-2,6-dicarbonitrile, 3-[5-(4-chlorophenyl)-2,3-dimethyl-1,2-oxazolidin-3-yl]pyridine, 3-chloro-5-(4-chlorophenyl)-4-(2,6-difluorophenyl)-6-methylpyridazine, 4-(4-chlorophenyl)-5-(2,6-difluorophenyl)-3,6-dimethylpyridazine, 5-amino-1,3,4-thiadiazole-2-thiol, 5-chloro-N′-phenyl-N′-(prop-2-yn-1-yl)thiophene-2-sulfonohydrazide, 5-fluoro-2-[(4-fluorobenzyl)oxy]pyrimidin-4-amine, 5-fluoro-2-[(4-methylbenzyl)oxy]pyrimidin-4-amine, 5-methyl-6-octyl[1,2,4]triazolo[1,5-a]pyrimidin-7-amine, ethyl (2Z)-3-amino-2-cyano-3-phenylprop-2-enoate, N′-(4-{[3-(4-chlorobenzyl)-1,2,4-thiadiazol-5-yl]oxy}-2,5-dimethylphenyl)-N-ethyl-N-methylimidoformamide, N-(4-chlorobenzyl)-3-[3-methoxy-4-(prop-2-yn-1-yloxy)phenyl]propanamide, N-[(4-chlorophenyl)(cyano)methyl]-3-[3-methoxy-4-(prop-2-yn-1-yloxy)phenyl]propanamide, N-[(5-bromo-3-chloropyridin-2-yl)methyl]-2,4-dichloropyridine-3-carboxamide, N-[1-(5-bromo-3-chloropyridin-2-yl)ethyl]-2,4-dichloropyridine-3-carboxamide, N-[1-(5-bromo-3-chloropyridin-2-yl)ethyl]-2-fluoro-4-iodopyridine-3-carboxamide, N-{(E)-[(cyclopropylmethoxy)imino][6-(difluoromethoxy)-2,3-difluorophenyl]methyl}-2-phenylacetamide, N-{(Z)-[(cyclopropylmethoxy)imino][6-(difluoromethoxy)-2,3-difluorophenyl]methyl}-2-phenylacetamide, N′-{4-[(3-tert-butyl-4-cyano-1,2-thiazol-5-yl)oxy]-2-chloro-5-methylphenyl}-N-ethyl-N-methylim idoformam ide, N-methyl-2-(1-{[5-methyl-3-(trifluoromethyl)-1H-pyrazol-1-yl]acetyl}piperidin-4-yl)-N-(1,2,3,4-tetrahydronaphthalen-1-yl)-1,3-thiazole-4-carboxamide, N-methyl-2-(1-{[5-methyl-3-(trifluoromethyl)-1H-pyrazol-1-yl]acetyl}piperidin-4-yl)-N-[(1R)-1,2,3,4-tetrahydronaphthalen-1-yl]-1,3-thiazole-4-carboxamide, N-methyl-2-(1-{[5-methyl-3-(trifluoromethyl)-1H-pyrazol-1-yl]acetyl}piperidin-4-yl)-N-[(1S)-1,2,3,4-tetrahydronaphthalen-1-yl]-1,3-thiazole-4-carboxamide, pentyl {6-[({[(1-methyl-1H-tetrazol-5-yl)(phenyl)methylidene]amino}oxy)methyl]pyridin-2-yl}carbamate, phenazine-1-carboxylic acid, quinolin-8-ol, quinolin-8-ol sulfate (2:1) and tert-butyl {6-[({[(1-methyl-1H-tetrazol-5-yl)(phenyl)methylene]amino}oxy)methyl]pyridin-2-yl}carbamate.

(16) Further compounds, for example 1-methyl-3-(trifluoromethyl)-N-[2′-(trifluoromethyl)biphenyl-2-yl]-1H-pyrazole-4-carboxamide, N-(4′-chlorobiphenyl-2-yl)-3-(difluoromethyl)-1-methyl-1H-pyrazole-4-carboxamide, N-(2′,4′-dichlorobiphenyl-2-yl)-3-(difluoromethyl)-1-methyl-1H-pyrazole-4-carboxamide, 3-(difluoromethyl)-1-methyl-N-[4′-(trifluoromethyl)biphenyl-2-yl]-1H-pyrazole-4-carboxamide, N-(2′,5′-difluorobiphenyl-2-yl)-1-methyl-3-(trifluoromethyl)-1H-pyrazole-4-carboxamide, 3-(difluoromethyl)-1-methyl-N-[4′-(prop-1-yn-1-yl)biphenyl-2-yl]-1H-pyrazole-4-carboxamide, 5-fluoro-1,3-dimethyl-N-[4′-(prop-1-yn-1-yl)biphenyl-2-yl]-1H-pyrazole-4-carboxamide, 2-chloro-N-[4′-(prop-1-yn-1-yl)biphenyl-2-yl]pyridine-3-carboxamide, 3-(difluoromethyl)-N-[4′-(3,3-dimethylbut-1-yn-1-yl)biphenyl-2-yl]-1-methyl-1H-pyrazole-4-carboxamide, N-[4′-(3,3-dimethylbut-1-yn-1-yl)biphenyl-2-yl]-5-fluoro-1,3-dimethyl-1H-pyrazole-4-carboxamide, 3-(difluoromethyl)-N-(4′-ethynylbiphenyl-2-yl)-1-methyl-1H-pyrazole-4-carboxamide, N-(4′-ethynylbiphenyl-2-yl)-5-fluoro-1,3-dimethyl-1H-pyrazole-4-carboxamide, 2-chloro-N-(4′-ethynylbiphenyl-2-yl)pyridine-3-carboxamide, 2-chloro-N-[4′-(3,3-dimethylbut-1-yn-1-yl)biphenyl-2-yl]pyridine-3-carboxamide, 4-(difluoromethyl)-2-methyl-N-[4′-(trifluoromethyl)biphenyl-2-yl]-1,3-thiazole-5-carboxamide, 5-fluoro-N-[4′-(3-hydroxy-3-methylbut-1-yn-1-yl)biphenyl-2-yl]-1,3-dimethyl-1H-pyrazole-4-carboxamide, 2-chloro-N-[4′-(3-hydroxy-3-methylbut-1-yn-1-yl)biphenyl-2-yl]pyridine-3-carboxamide, 3-(difluoromethyl)-N-[4′-(3-methoxy-3-methylbut-1-yn-1-yl)biphenyl-2-yl]-1-methyl-1H-pyrazole-4-carboxamide, 5-fluoro-N-[4′-(3-methoxy-3-methylbut-1-yn-1-yl)biphenyl-2-yl]-1,3-dimethyl-1H-pyrazole-4-carboxamide, 2-chloro-N-[4′-(3-methoxy-3-methylbut-1-yn-1-yl)biphenyl-2-yl]pyridine-3-carboxamide, (5-bromo-2-methoxy-4-methylpyridin-3-yl)(2,3,4-trimethoxy-6-methylphenyl)methanone, N-[2-(4-{[3-(4-chlorophenyl)prop-2-yn-1-yl]oxy}-3-methoxyphenyl)ethyl]-N2-(methylsulfonyl)valinamide, 4-oxo-4-[(2-phenylethyl)amino]butanoic acid and but-3-yn-1-yl {6-[({[(Z)-(1-methyl-1H-tetrazol-5-yl)(phenyl)methylene]amino}oxy)methyl]pyridin-2-yl}carbamate.

Examples of bactericides include the following:

bronopol, dichlorophen, nitrapyrin, nickel dimethyldithiocarbamate, kasugamycin, octhilinon, furancarboxylic acid, oxytetracycline, probenazole, streptomycin, tecloftalam, copper sulfate and other copper preparations.

Examples of insecticides, acaricides and nematicides include the following:

(1) Acetylcholinesterase (AChE) inhibitors, such as carbamates, e.g. alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, XMC and xylylcarb; or organophosphates, e.g. acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, imicyafos, isofenphos, isopropyl O-(methoxyaminothiophosphoryl) salicylate, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, triclorfon and vamidothion.

(2) GABA-gated chloride channel antagonists, for example cyclodiene-organochlorines, e.g. chlordane and endosulfan; or phenylpyrazoles (fiproles), e.g. ethiprole and fipronil.

(3) Sodium channel modulators/voltage-gated sodium channel blockers, for example pyrethroids, e.g. acrinathrin, allethrin, d-cis-trans allethrin, d-trans allethrin, bifenthrin, bioallethrin, bioallethrin s-cyclopentenyl isomer, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1R)-trans isomers], deltamethrin, empenthrin [(EZ)-(1R) isomers], esfenvalerate, etofenprox, fenpropathrin, fenvalerate, flucythrinate, flumethrin, tau-fluvalinate, halfenprox, imiprothrin, kadethrin, permethrin, phenothrin [(1R)-trans isomer], prallethrin, pyrethrins (pyrethrum), resmethrin, silafluofen, tefluthrin, tetramethrin, tetramethrin [(1R) isomers)], tralomethrin and transfluthrin; or DDT; or methoxychlor.

(4) Nicotinergic acetylcholine receptor (nAChR) agonists, for example neonicotinoids, e.g. acetamiprid, clothianidin, dinotefuran, imidacloprid, nitenpyram, thiacloprid and thiamethoxam; or nicotine.

(5) Allosteric activators of the nicotinergic acetylcholine receptor (nAChR), for example spinosyns, e.g. spinetoram and spinosad.

(6) Chloride channel activators, for example avermectins/milbemycins, e.g. abamectin, emamectin benzoate, lepimectin and milbemectin.

(7) Juvenile hormone imitators, for example juvenile hormone analogs e.g. hydroprene, kinoprene and methoprene; or fenoxycarb; or pyriproxyfen.

(8) Active ingredients with unknown or nonspecific mechanisms of action, for example alkyl halides, e.g. methyl bromide and other alkyl halides; or chloropicrin; or sulfuryl fluoride; or borax; or tartar emetic.

(9) Selective antifeedants, for example pymetrozine; or flonicamid.

(10) Mite growth inhibitors, for example clofentezine, hexythiazox and diflovidazin; or etoxazole.

(11) Microbial disruptors of the insect gut membrane, for example Bacillus thuringiensis subspecies israelensis, Bacillus sphaericus, Bacillus thuringiensis subspecies aizawai, Bacillus thuringiensis subspecies kurstaki, Bacillus thuringiensis subspecies tenebrionis, and BT plant proteins: Cry1Ab, Cry1Ac, Cry1Fa, Cry2Ab, mCry3A, Cry3Ab, Cry3Bb, Cry34/35Ab1.

(12) Oxidative phosphorylation inhibitors, ATP disruptors, for example diafenthiuron; or organotin compounds, e.g. azocyclotin, cyhexatin and fenbutatin oxide; or propargite; or tetradifon.

(13) Oxidative phosphorylation decouplers that interrupt the H proton gradient, for example chlorfenapyr, DNOC and sulfluramid.

(14) Nicotinergic acetylcholine receptor antagonists, for example bensultap, cartap hydrochloride, thiocyclam, and thiosultap-sodium.

(15) Chitin biosynthesis inhibitors, type 0, for example bistrifluron, chlorfluazuron, diflubenzuron, flucycloxuron, flufenoxuron, hexaflumuron, lufenuron, novaluron, noviflumuron, teflubenzuron and triflumuron.

(16) Chitin biosynthesis inhibitors, type 1, for example buprofezin.

(17) Molting disruptors, dipteran, for example cyromazine.

(18) Ecdysone receptor agonists, for example chromafenozide, halofenozide, methoxyfenozide and tebufenozide.

(19) Octopaminergic agonists, for example amitraz.

(20) Complex-III electron transport inhibitors, for example hydramethylnon; or acequinocyl; or fluacrypyrim.

(21) Complex-I electron transport inhibitors, for example METI acaricides, e.g. fenazaquin, fenpyroximate, pyrimidifen, pyridaben, tebufenpyrad and tolfenpyrad; or rotenone (Derris).

(22) Voltage-dependent sodium channel blockers, for example indoxacarb; or metaflumizone.

(23) Inhibitors of acetyl-CoA carboxylase, for example tetronic and tetramic acid derivatives, e.g. spirodiclofen, spiromesifen and spirotetramat.

(24) Complex-IV electron transport inhibitors, for example phosphines, e.g. aluminum phosphide, calcium phosphide, phosphine and zinc phosphide; or cyanide.

(25) Complex-II electron transport inhibitors, for example cyenopyrafen.

(26) Ryanodine receptor effectors, for example diamides, e.g. chlorantraniliprole and flubendiamide.

Further active ingredients with an unknown mechanism of action, for example amidoflumet, azadirachtin, benclothiaz, benzoximate, bifenazate, bromopropylate, chinomethionat, cryolite, cyantraniliprole (Cyazypyr), cyflumetofen, dicofol, diflovidazin, fluensulfone, flufenerim, flufiprole, fluopyram, fufenozide, imidaclothiz, iprodione, pyridalyl, pyrifluquinazon and iodomethane; and additionally preparations based on Bacillus firmus (I-1582, BioNeem, Votivo).

Biological control agents are known to those skilled in the art and are described, for example, in “The Manual of Biocontrol Agents, 5^{th} edition, editor: Dr. Roma Gwynn, BCPC 2014”.

Examples of repellents include diethyltolylamide, ethylhexanediol and butopyronoxyl.

Examples of plant nutrients include customary inorganic or organic fertilizers for supplying plants with macro- and/or micronutrients.

The fatty acid derivatives of the formula (I) and compositions comprising one or more fatty acid derivatives of the formula (I) can be used in all customary formulation types, preferably in liquid compositions. In principle, however, the compounds may also be used in solid compositions.

Standard formulation forms for agrochemical compositions are, for example, water-soluble liquids (SL), emulsion concentrates (EC), emulsions in water (EW), suspension concentrates (SC, SE, FS, OD), water-dispersible granules (WG), granules (GR) and capsule concentrates (CS); these and further possible formulation types are described, for example, by Crop Life International and in Pesticide Specifications, Manual on development and use of FAO and WHO specifications for pesticides, FAO Plant Production and Protection Papers—173, prepared by the FAO/WHO Joint Meeting on Pesticide Specifications, 2004, ISBN: 9251048576.

The agrochemical compositions may contain auxiliaries. The auxiliaries may, for example, be extenders, solvents, spontaneity promoters, carriers, emulsifiers, dispersants, antifreezes, biocides and/or thickeners.

Auxiliaries used may be those substances which are suitable for imparting particular properties, such as particular physical, technical and/or biological properties, to the formulation of the active ingredient or to the use forms prepared from these compositions (for example ready-to-use crop protection compositions such as spray liquids or seed dressing products).

Suitable extenders are, for example, water, polar and nonpolar organic chemical liquids, for example from the classes of the aromatic and nonaromatic hydrocarbons (such as paraffins, alkylbenzenes, alkylnaphthalenes, chlorobenzenes), the alcohols and polyols (which may optionally also be substituted, etherified and/or esterified), the ketones (such as acetone, cyclohexanone), esters (including fats and oils) and (poly)ethers, the unsubstituted and substituted amines, amides, lactams (such as N-alkylpyrrolidones) and lactones, the sulfones and sulfoxides (such as dimethyl sulfoxide).

In principle, it is possible to use any suitable carriers. Useful carriers especially include: for example ammonium salts and natural rock flours such as kaolins, aluminas, talc, chalk, quartz, attapulgite, montmorillonite or diatomaceous earth, and synthetic rock flour such as finely divided silica, aluminum oxide and natural or synthetic silicates, resins, waxes and/or solid fertilizers. Mixtures of such carriers can likewise be used. Useful carriers for granules include: for example crushed and fractionated natural rocks such as calcite, marble, pumice, sepiolite, dolomite, and synthetic granules of inorganic and organic flours, and also granules of organic material such as sawdust, paper, coconut shells, corn cobs and tobacco stalks.

It is also possible to use liquefied gaseous extenders or solvents. Especially suitable are those extenders or carriers which are gaseous at standard temperature and under standard pressure, for example aerosol propellants such as halohydrocarbons, or else butane, propane, nitrogen and carbon dioxide.

Examples of emulsifiers and/or foam formers, dispersants or wetting agents with ionic or nonionic properties, or mixtures of these surfactants, are salts of polyacrylic acid, salts of lignosulfonic acid, salts of phenolsulfonic acid or naphthalenesulfonic acid, polycondensates of ethylene oxide with fatty alcohols or with fatty acids or with fatty amines, with substituted phenols (preferably alkylphenols or arylphenols), salts of sulfosuccinic esters, taurine derivatives (preferably alkyl taurates), phosphoric esters of polyethoxylated alcohols or phenols, fatty acid esters of polyols, and derivatives of the compounds containing sulfates, sulfonates and phosphates, for example alkylaryl polyglycol ethers, alkyl sulfonates, alkyl sulfates, arylsulfonates, protein hydrolyzates, lignosulfite waste liquids and methyl cellulose. The presence of a surfactant is advantageous when one of the active ingredients and/or one of the inert carriers is insoluble in water and when application is effected in water.

Further auxiliaries which may be present in the compositions and the use forms derived therefrom are dyes such as inorganic pigments, for example iron oxide, titanium oxide and Prussian Blue, and organic dyes such as alizarin dyes, azo dyes and metal phthalocyanine dyes, and nutrients and trace nutrients such as salts of iron, manganese, boron, copper, cobalt, molybdenum and zinc. Additional components may be stabilizers, such as cold stabilizers, preservatives, antioxidants, light stabilizers, or other agents which improve chemical and/or physical stability. Foam generators or defoamers may additionally be present.

Preservatives used may be organic acids and esters thereof, for example ascorbic acid, ascorbyl palmitate, sorbate, benzoic acid, methyl and propyl 4-hydroxybenzoate, propionates, phenol, for example 2-phenylphenate, 1,2-benzisothiazolin-3-one, formaldehyde, sulfurous acid and salts thereof.

Suitable defoamers are fatty acid alkyl ester alkoxylates, organopolysiloxanes such as polydimethylsiloxanes and mixtures thereof with microfine, optionally silanized silica; perfluoroalkylphosphonates and -phosphinates, paraffins, waxes and microcrystalline waxes, and mixtures thereof with silanized silica. Also advantageous are mixtures of various foam inhibitors, for example those of silicone oil, paraffin oil and/or waxes.

The functional polymers which may be present in the agrochemical compositions according to the invention are high molecular weight compounds of synthetic or natural origin having a molar mass of greater than 10000. The functional polymers may act, for example, as an additional anti-drift agent or increase rain resistance.

In addition, the compositions and the use forms derived therefrom may also comprise, as additional auxiliaries, stickers such as carboxymethyl cellulose and natural and synthetic polymers in the form of powders, granules or latices, such as gum arabic, polyvinyl alcohol and polyvinyl acetate, or else natural phospholipids such as cephalins and lecithins and synthetic phospholipids. Further possible auxiliaries are mineral and vegetable oils.

It is possible if appropriate for still further auxiliaries to be present in the compositions and the use forms derived therefrom. Examples of such additives are fragrances, protective colloids, binders, adhesives, thickeners, thixotropic agents, penetrants, retention promoters, stabilizers, sequestrants, complexing agents, humectants, spreaders.

In general, the agrochemical substances can be combined with any solid or liquid additive which is commonly used for formulation purposes.

Useful retention promoters include all those substances which reduce dynamic surface tension, for example dioctyl sulfosuccinate, or increase viscoelasticity, for example hydroxypropylguar polymers.

Useful penetrants in the present context are all those substances which are typically used to improve the penetration of agrochemical actives into plants.

Penetrants are defined in this context by their ability to penetrate from the (generally aqueous) application liquid and/or from the spray deposit into the cuticle of the plant and hence increase the mobility of active ingredients in the cuticle. The method described in the literature (Baur et al., 1997, Pesticide Science 51, 131-152) can be used to determine this property. Examples include alcohol alkoxylates, for example coconut fat ethoxylate (10) or isotridecyl ethoxylate (12), fatty acid esters, for example rapeseed oil methyl ester or soya oil methyl ester, fatty amine alkoxylates, for example tallowamine ethoxylate (15) or ammonium salts and/or phosphonium salts, for example ammonium sulfate or diammonium hydrogen phosphate.

The agrochemical compositions may optionally contain further action-improving adjuvants. Examples of further adjuvants are penetrants, for example vegetable oils, for example rapeseed oil, sunflower oil, mineral oils, for example paraffin oils, alkyl esters of vegetable fatty acids, for example rapeseed oil methyl ester or soybean oil methyl ester, or alkanol alkoxylates and/or spreaders, for example alkylsiloxanes and/or salts, for example organic or inorganic ammonium or phosphonium salts, for example ammonium sulfate or diammonium hydrogenphosphate and/or retention promoters, for example dioctyl sulfosuccinate or hydroxypropylguar polymers and/or humectants, for example glycerol and/or fertilizers, for example ammonium-, potassium- or phosphorus-containing fertilizers and/or agents which promote sticking to the leaf surface.

Agrochemical compositions of the invention that are agrochemical concentrates preferably contain between 0.00001% and 98% by weight of agrochemical active(s), more preferably between 0.01% and 95% by weight of agrochemical active(s), more preferably between 0.5% and 90% by weight of agrochemical active(s), based on the weight of the agrochemical concentrate.

The content of agrochemical active(s) in the use forms prepared from the agrochemical concentrate can vary within wide limits. The concentration of the agrochemical active(s) in the use forms, especially in spray liquids, may typically be between 0.0000001% and 95% by weight of agrochemical active(s), preferably between 0.00001% and 5% by weight of agrochemical active(s), more preferably between 0.0001% and 1% by weight of agrochemical active(s) and especially preferably between 0.001% and 1% by weight of agrochemical active(s), based on the weight of the use form, especially of the spray liquid. Application is accomplished in a customary manner appropriate to the use forms.

The agrochemical compositions are produced, for example, by mixing the components with one another in the particular ratios desired. If the agrochemical active(s) is a solid substance, it is generally used either in finely ground form or in the form of a solution or suspension in an organic solvent or water. If the agrochemical active(s) is liquid, there is frequently no need to use an organic solvent. It is also possible to use a solid active substance in the form of a melt. The temperatures can be varied within a particular range in the course of performance of the process. In general, working temperatures are between 0° C. and 80° C., preferably between 10° C. and 60° C.

According to the formulation type, the production of the agrochemical concentrate is possible in various ways which are sufficiently well known to those skilled in the art. The procedure in the production may, for example, be to mix the fatty acid derivatives of the formula (I) with one or more agrochemical active(s) and optionally with auxiliaries. The sequence in which the components are mixed with one another is arbitrary. Useful equipment in the production is customary equipment which is used for production of agrochemical compositions. The agrochemical concentrates according to the invention are preferably applied to fields in the form of spray liquids. The spray liquids are produced by diluting concentrate formulations with a defined amount of water.

“Application” of an agrochemical composition in the form of a spray liquid containing one or more agrochemical active in the context of the invention is understood to mean the application of an aqueous spray liquid containing one or more agrochemical actives to the species to be treated, for example the plants to be treated, and/or the locus thereof.

The invention provides for the use of fatty acid derivatives of the formulae (I), preferably (Ia) for improving wettability, retention and/or uptake of agrochemical actives in and on target organisms, preferably for improving wettability, retention and or foliar uptake in and on plants.

The invention provides for the use of one or more fatty acid derivatives of formula (I) for improving wettability when applying an agrochemical composition.

It is known from the literature that, given a timespan of relevance for the spray application of agrochemicals in aqueous dilution (called the surface age in the bubble pressure method) of 200 milliseconds, the value for dynamic surface tension in [mN/m] correlates with the wettability and adhesion on plants that are difficult to wet, such as barley (cereal). A value of 50 mN/m (at 20-21° C.) with respect to water (72.8 mN/m) results in an improvement in the adhesion from “zero adhesion” (0%) to about 50% (Baur P., Pontzen R.; 2007; Basic features of plant surface wettability and deposit formation and the impact of adjuvant; in R. E. Gaskin ed. Proceedings of the 8th International Symposium on Adjuvants for Agrochemicals; Publisher: International Society for Agrochemical Adjuvants (ISAA), Columbus, Ohio, USA).

Moreover, lowering of the surface tension improves penetration into fine pores in the soil, and also contributes to promoting the efficacy of soil-active pesticides on application to dry arable land or to peaty soils.

In the context of the present invention, improved wetting characteristics are therefore defined via a reduction in the surface tension (measured with the Krüss BP2100 tensiometer, for determination of the dynamic surface tension by means of the bubble pressure method) of a 0.1% by weight aqueous solution at 200 ms, which is preferably lowered to less than 60 mN/m, and more preferably to less than 45 mN/m.

It has been found that the fatty acid derivatives of the formula (I) in a 0.03% by weight aqueous solution lower the dynamic surface tension at 200 ms to less than 55 mN/m.

The invention further provides for the use of one or more fatty acid derivatives of the formula (I) for improving the retention and/or the foliar uptake of agrochemical actives in and on plants.

In the context of the invention, therefore, “fatty acid derivatives of the formula (I) that lead to an enhanced uptake of an agrochemical active” are understood to mean substances which, given comparable use concentrations and given comparable observation times, bring about uptake of agrochemical actives into the target organism at compared to the agrochemical active alone by at least 5% and more preferably 10% and most preferable 20%.

The invention further provides a method of enhancing uptake of an agrochemical active into a target organism when appyling agrochemical compositions, wherein an aqueous spray liquid is sprayed onto the species to be treated, for example plants, and/or the locus thereof, wherein the spray liquid comprising agrochemical active(s) comprises one or more fatty acid derivatives of the formula (I) in amounts of 0.0001% to 1% by weight, more preferably of 0.001% to 0.5% by weight, especially preferably of 0.01% to 0.2% by weight and exceptionally preferably of 0.03% to 0.1% by weight, based in each case on the total weight of the spray liquid.

In a preferred embodiment the use of one or more fatty acid derivatives of formula (I) leads to an improvement of wettability as well as retention and/or foliar uptake of agrochemical actives.

The radical definitions, value ranges and elucidations given above, in general terms or in ranges of preference, can be combined with one another as desired, i.e. including combinations between the particular ranges and ranges of preference.

The invention is illustrated hereinafter by examples, but these should in no way be regarded as a restriction.

### EXAMPLES

The percentages stated hereinafter are percent by weight (% by weight), unless explicitly stated otherwise.

The raw materials used are:

Water deionized water or tap water

MCPA MCPA auxin herbicide>99% purity, Sigma aldrich

Pelargonic acid Pelargonic acid>99% purity, Novamont

Genagen C 100 Cocos fatty acid ester ethoxylate, Clariant

Genapol X 060 Tridecyl alcohol ethoxylate, Clariant

Flufenacet Oxyacetamide herbicide, Sigma Aldrich

Mesosulfuron-methyl Sulfonylurea herbicide, Sigma Aldrich

lodosulfuron-methyl Sulfonylurea herbicide, Sigma Aldrich

Imidacloprid Neonicotinoide insecticide, Sigma Aldrich

Mesotrione Triketone herbicide, Sigma Aldrich

Benzyladenine Cytokinin plant growth regulator, Sigma Aldrich

Milbemectin Avermectin acaricide, Sigma Aldrich

Milbeknock Milbemectin EC formulation, Belchim

### Example 1

### Preparation of the Fatty Acid Derivatives of the Invention

The compounds according to the invention are listed in Table 1. All test substances were liquid, which makes them easy to handle and pourable.

TABLE 1

| | | | | | | | | Conversion rate |
|---|---|---|---|---|---|---|---|---|
| | | | | | | | | (according |
| Test substance | Description | R1 | R2 | R3 | m | n | R4 | to acid value) |
| A1 | Pelargonic acid | C8 | H | H | 0 | C | Me | >85 |
| | 6 EO ester methyl ether | | | | | | | |
| A2 | C8/C10 fatty acid | C7/C9 | H | H | 0 | C | Me | >85 |
| | 6 EO ester methyl ether | | | | | | | |

### General Procedure for the Synthesis of Alcohol Ethoxylate Esters A1 and A2

Alcohol ethoxylates were synthesized according to standard alkoxylation procedures as described in (e.g. US2012/310004). In a flask, equipped with a Dean-Stark-head, alcohol ethoxylates or glycerol were mixed with the respective carboxylic acid at a stoichiometric mixture, a catalytic amount of sulfuric acid was added and the mixture was heated up to 200° C. upon stirring under a constant stream of nitrogen. Reaction progress was followed by water separation and acid value. The final product was characterized by NMR spectroscopy and titration methods.

### Example 2

### Dynamic Surface Tension

Dynamic surface tension was determined via the bubble pressure method (BP2100 tensiometer, Krüss). Given a timespan of relevance for the spray application of agrochemicals in aqueous dilution (called the surface age in the bubble pressure method) of 200 milliseconds (ms), the value for dynamic surface tension in [mN/m] correlates with the adhesion on plants that are difficult to wet, such as barley (cereal). A value of 50 mN/m (at 20-21° C.) with respect to water (72.8 mN/m) results in an improvement in the adhesion from “zero adhesion” (0%) to about 50% (Baur P., Pontzen R.; 2007; Basic features of plant surface wettability and deposit formation and the impact of adjuvant; in R. E. Gaskin ed. Proceedings of the 8th International Symposium on Adjuvants for Agrochemicals; Publisher: International Society for Agrochemical Adjuvants (ISAA), Columbus, Ohio, USA).

TABLE 2
Dynamic surface tension

| | | Dynamic Surface tension [mN/m] | | | | |
|---|---|---|---|---|---|---|
| | | Concentration | | | | |
| Test substance | | in g/L | 20 ms | 50 ms | 100 ms | 200 ms |
| A1 | C9 6 EO fatty acid methyl ester | 0.3 | 61.2 | 57.3 | 54.4 | 51.5 |
| A1 | C9 6 EO fatty acid methyl ester | 1 | 47.6 | 44.5 | 42.1 | 39.8 |
| A1 | C9 6 EO fatty acid methyl ester | 3 | 33.7 | 32.0 | 30.8 | 29.5 |
| A1 | C9 6 EO fatty acid methyl ester | 10 | 30.2 | 29.3 | 28.6 | 27.9 |
| A2 | C8/10 6 EO fatty acid methyl ester | 0.3 | 54.5 | 54.5 | 54.5 | 54.5 |
| A2 | C8/10 6 EO fatty acid methyl ester | 1 | 42.0 | 42.0 | 42.0 | 42.0 |
| A2 | C8/10 6 EO fatty acid methyl ester | 3 | 31.5 | 31.5 | 31.5 | 31.5 |
| A2 | C8/10 6 EO fatty acid methyl ester | 10 | 28.5 | 28.5 | 28.5 | 28.5 |
| Ref | Genagen C 100 | 0.3 | 67.5 | 64.5 | 61.7 | 59.8 |
| Ref | Genagen C 100 | 1 | 60.7 | 57.7 | 55.2 | 52.1 |
| Ref | Genagen C 100 | 3 | 54.1 | 50 | 47.3 | 45.2 |
| Ref | Genapol X 060 | 0.3 | 66.7 | 66.8 | 62.2 | 57.5 |
| Ref | Genapol X 060 | 1 | 65.1 | 59.6 | 53.7 | 47 |
| Ref | Genapol X 060 | 3 | 57.1 | 51 | 45 | 39.1 |

The low dynamic surface tensions of the inventive compounds show their excellent suitability as rapid wetting agents, including its suitability as a sticking promoter, in the spray application of crop protection products.

Compared to commercially used fatty acid ester ethoxylates such as Genagen C 100 the inventive compounds show considerably better wetting properties. Even compared to industry standard wetting agents, such as Genapol X 060, the inventive compounds show a stronger reduction of dynamic surface tension at lower concentrations considerably resulting in better wetting properties.

### Example 3

### Penetration Enhancement of Agrochemical Actives

Surfactants can affect the absorption of (active) ingredients through membranes such as skin, films or the plant cuticle. As a “finite-dose” application, it is known for the single administration or application of a solution, cream, gel etc. to a membrane that the absorption of active ingredient can be influenced by some additives such as surfactants even after wetting. This effect is independent of the interfacial effect in water, is often highly concentration-dependent and takes place for the most part after evaporation of water and any solvents present as a result of the interaction, for example, with active ingredient, membrane and environmental factors. For various surfactants, it is observed after addition to active ingredient preparations that the penetration of a particular active ingredient is promoted to an enormous degree by some surfactants, whereas others are entirely ineffective.

The plant cuticle is a lipophilic solubility membrane (lipid membrane) without pores or holes, and the results described are also expected for other nonporous lipophilic solubility membranes with these or other active ingredients. The principle of the method has been published and described in detail e.g. in WO-A-2005/194844 or WO2017211572 A1). The leaf cuticles were enzymatically isolated in the manner described in the literature from apple leaves of orchard trees in a commercial stone fruit growing facility near Frankfurt am Main in 2017. The stomata-free cuticles were first dried under air and then installed into stainless steel diffusion cells. After application to the original upper side of the leaf and evaporation of the test liquid, i.e. of the spray liquids of the active ingredients with or without the inventive substances or comparative compositions, the diffusion cells were transferred into thermostated blocks and charged with aqueous liquid. The water used to make up the aqueous test liquids was local tap water (of known composition). At regular intervals, aliquot samples were taken and the proportion of active ingredient penetrated was determined by HPLC or alternatively by radio-chemical method where radio-labelled active ingredient was used as tracer to determine the concentration. During the experiment, the temperature in the system (block, diffusion cells, liquids, etc.) and the air humidity above the spray deposit on the cuticle were controlled. In the experiment, relative air humidity was constant throughout at 56% relative air humidity (air over supersaturated calcium nitrate) at a constant 10° C. or 25° C. The analytical determination by means of HPLC (1290 Infinity, Agilent) was effected thereafter with a Kinetex column 30×2, 1 mm, 2.6μ C18 100 A (Phenomenex), taking a 20 μL aliquot as injection volume at the specified times. In each case, the geometric mean values of the penetration for intact membranes at the mean measurement times are given. According to the variant (active ingredient×test additive/formulation), 7-8 repetitions were set up. The coefficient of variation was below 35%, which is a typical biological variability for penetration for numerous plants.

TABLE 3
Penetration of MCPA (agrochemical active concentration 1.5
g/L in spray liquid) in the presence of test substances

| | Mean penetration for MCPA (amount of active | | |
|---|---|---|---|
| | ingredient 1.5 g/L) after time (n = 4-8) in % | | |
| Test substance | Amount g/L | 0.5 day | 1 day |
| Control | — | 9.0 | 17.1 |
| (pure active) | | | |
| A1 | 0.3 | 34.2 | 45.5 |
| A1 | 1.0 | 46.9 | 53.9 |

*25° C./56% rel. air humidity

The table shows that the test substance A1 strongly increases the uptake of the active ingredient compared to the commercial formulation.

TABLE 4
Penetration of Flufenacet (agrochemical active concentration
0.75 g/L in spray liquid) in the presence of test substances

| | Mean penetration for Flufenacet (amount of active | | |
|---|---|---|---|
| | ingredient 0.75 g/L) after time (n = 4-8) in % | | |
| Test substance | Amount g/L | 1 day | 2 days |
| Control | — | 0.4 | 0.7 |
| (pure active) | | | |
| Sunfire SC 500 | — | 0.4 | 1.0 |
| (commercial | | | |
| formulation) | | | |
| A1 | 1.0 | 10.7 | 16.9 |
| A1 | 10 | 18.2 | 28.0 |

*10° C./61% rel. air humidity

The table shows that the test substance A1 strongly increases the uptake of the active ingredient compared to the commercial formulation.

TABLE 5
Penetration of Mesosulfuron-methyl (agrochemical active concentration
0.1 g/L in spray liquid) in the presence of test substances

| | Mean penetration for Mesosulfuron-methyl (amount of | | |
|---|---|---|---|
| | active ingredient 0.1 g/L) after time (n = 4-8) in % | | |
| Test substance | Amount g/L | 1 day | 2 days |
| Control | — | 0 | 0 |
| (pure active) | | | |
| A1 | 1.0 | 1.9 | 3.6 |
| A1 | 3.0 | 4.2 | 5.2 |
| A1 | 10 | 9.2 | 10.9 |

*10° C./61% rel. air humidity

The table shows that the test substance A1 strongly increases the uptake of the active ingredient.

TABLE 6
Penetration of lodosulfuron-methyl (agrochemical active concentration
0.1 g/L in spray liquid) in the presence of test substances

| | Mean penetration for lodosulfuron-methyl (amount of | | |
|---|---|---|---|
| | active ingredient 0.1 g/L) after time (n = 4-8) in % | | |
| Test substance | Amount g/L | 1 day | 2 days |
| Control | — | 0 | 0 |
| (pure active) | | | |
| A1 | 0.3 | 1.0 | 1.5 |
| A1 | 1.0 | 2.3 | 3.3 |
| A1 | 3.0 | 7.6 | 8.8 |

*10° C./61% rel. air humidity

The table shows that the test substance A1 strongly increases the uptake of the active ingredient.

TABLE 7
Penetration of Mesotrione (agrochemical active concentration
0.5 g/L in spray liquid) in the presence of test substances

| | Mean penetration for Mesotrione (amount of active | | |
|---|---|---|---|
| | ingredient 0.5 g/L) after time (n = 4-8) in % | | |
| Test substance | Amount g/L | 1 day | 2 days |
| Control | — | 0 | 0 |
| (pure active) | | | |
| A1 | 0.3 | 0.08 | 1.0 |
| A1 | 1.0 | 3.8 | 4.7 |

The table shows that the test substance A1 increases the uptake of the active ingredient.

TABLE 8
Penetration of Imidacloprid (agrochemical active concentration
0.5 g/L in spray liquid) in the presence of test substances

| | Mean penetration for Imidacloprid (amount of active | | |
|---|---|---|---|
| | ingredient 0.5 g/L) after time (n = 4-8) in % | | |
| Test substance | Amount g/L | 1 day | 4 days |
| Control | — | 0.5 | 1.3 |
| (pure active) | | | |
| A1 | 0.3 | 2.8 | 3.8 |
| A1 | 1.0 | 31.7 | 38.2 |
| Genagen C 100 | 1.0 | 14.5 | 16.6 |
| (Reference) | | | |

The table shows that the test substance A1 strongly increases the uptake of the agrochemical active.

TABLE 9
Penetration of Milbemectin (agrochemical active concentration
0.03 g/L in spray liquid) in the presence of test substances

| | Mean penetration for Milbemectin (amount of | | |
|---|---|---|---|
| | agrochemical active 0.03 g/L) after time (n = 4-8) in % | | |
| Test substance | Amount g/L | 1 day | 2 days |
| Milbeknock | 0.03 (active) | 3.0 | 1.4 |
| (commercial | | | |
| formulation) | | | |
| A1 | 1.5 | 4.3 | 4.2 |
| A1 | 3.0 | 4.7 | 5.4 |

The table shows that the test substance A1 strongly increases the uptake of the agrochemical active compared to the commercial formulation.

TABLE 10
Penetration of Benzyladenine (agrochemical active concentration
0.1 g/L in spray liquid) in the presence of test substances

| | Mean penetration for Benzyladenine (amount of | | |
|---|---|---|---|
| | agrochemical active 0.1 g/L) after time (n = 4-8) in % | | |
| Test substance | Amount g/L | 1 day | 2 days |
| A1 | 0.3 | 4.2 | 4.5 |
| A1 | 0.8 | 9.7 | 10.6 |
| A1 | 1.5 | 17.2 | 17.9 |
| A1 | 3.0 | 17.9 | 18.6 |

The table shows that the test substance A1 strongly increases the uptake of the agrochemical active.

### Example 4

The plant compatibility of fatty acid derivatives according to formula (I) was checked using Poinsettia (e.g. variety Merlot) as indicator plant. If no necroses or other phytotoxicity symptoms, such as leaf curl-up or deformations were observed the substance is considered plant compatible and not phytotoxic.

The fatty acid derivatives according to formula (I) did not show relevant symptoms at concentrations below 2 g/L. For higher concentrations, some phytotoxic effects could be observed. The tested reference substances (ethoxylated lauryl alcohol at 1 g/L and Genagen C 100 at 1 g/L) caused strong distinct necroses within one day.

1. A method for improving wettability, retention and/or the uptake of an agrochemical active in and on a target organism, comprising the step of contacting the target organism with a composition comprising at least one fatty acid derivative of the formula (I) 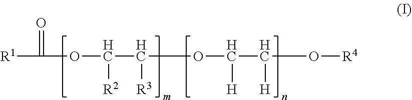
wherein
R¹ is an alkyl group containing 5 to 17 carbon atoms, which is linear or branched
R², R³ are, independently, hydrogen, methyl, ethyl or hydroxymethyl with the proviso that one of R² and R³ is hydrogen and the other is different from hydrogen
m, n are numbers from 0 to 17, with the proviso that m+n≥1, and m+n+p<18 where
the different monomers can be arranged in statistical order, alternatingly or as a block copolymer;
R⁴ is hydrogen or an alkyl group containing 1 to 10 carbon atoms, which is linear or branched,
wherein the agrochemical active is different from the fatty acid derivative of formula (I).

2. The method according to claim 1 for improving wettability of the agrochemical active on the target organism.

3. The method according to claim 1 for improving retention of the agrochemical active in and on the target organism.

4. The method according to claim 1 for improving the uptake of the agrochemical active in the target organism.

5. The method according to claim 1, wherein:
R¹ is an alkyl group containing 5 to 17 carbon atoms, which is linear or branched
R², R³ are, independently, hydrogen, methyl, ethyl or hydroxymethyl with the proviso that one of R² and R³ is hydrogen and the other is different from hydrogen
m, n are numbers from 0 to 17, with the proviso that m+n≥1, and m+n+p<18 where
the different monomers can be arranged in statistical order, alternatingly or as a block copolymer;
R⁴ is hydrogen or an alkyl group containing 1 to 10 carbon atoms, which is linear or branched.

6. The method according to claim 1, wherein the at least one fatty acid derivative is of the formula (Ia), 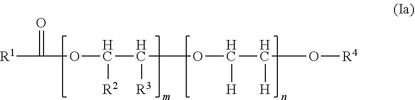
wherein
R¹ is an alkyl group containing 5 to 13 carbon atoms, which is linear or branched;
R², R³ are, independently, hydrogen, methyl, ethyl or hydroxymethyl;
m, n are numbers from 0 to 12, with the proviso that m+n>4, and m+n<12 where
the different monomers can be arranged in statistical order, alternatingly or as a block copolymer,
R⁴ is a methyl group.

7. The method according to claim 1, wherein:
R¹ is a linear alkyl group
R¹ is an alkyl group with 5 to 11, carbon atoms,
R², R³ are hydrogen, methyl or ethyl, and
m is a number from 0 to 5.

8. The method according to claim 1, where in formula (I), m+n is >4.

9. The method according to claim 1, where in m is 0, and n is a number from >4.

10. The method according to claim 1, wherein
R¹ is a linear alkyl group with 7 to carbon atoms;
m is 0;
n is a number from >4, and
R⁴ is a methyl group.

11. The method according to claim 1, where the fatty acid derivative of formula (I) is employed in the form of an agrochemical concentrate in a concentration of from 0.01 to 99% by weight, based on the whole agrochemical concentrate.

12. The method according to claim 1, wherein the fatty acid derivative of the formula (I) is employed in the form of a spray liquid in a concentration of from 0.0001 to 1% by weight, based on the whole spray liquid.

13. An agrochemical composition which is an agrochemical concentrate comprising at least one agrochemical active ingredient, which is different from the fatty acid derivative of the formula (I), 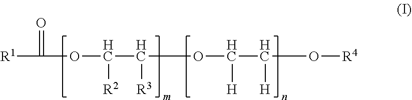
wherein
R¹ is an alkyl group containing 5 to 17 carbon atoms, which is linear or branched
R², R³ are, independently, hydrogen, methyl, ethyl or hydroxymethyl with the proviso that one of R² and R³ is hydrogen and the other is different from hydrogen
m, n are numbers from 0 to 17, with the proviso that m+n≥1, and m+n+p<18 where
the different monomers can be arranged in statistical order, alternatingly or as a block copolymer;
R⁴ is hydrogen or an alkyl group containing 1 to 10 carbon atoms, which is linear or branched,
and one or more fatty acid derivative of the formula (Ia) as an adjuvant, 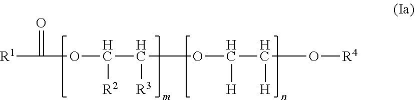
wherein
R¹ is an alkyl group containing 5 to 13 carbon atoms, which is linear or branched;
R², R³ are, independently, hydrogen, methyl, ethyl or hydroxymethyl;
m, n are numbers from 0 to 12, with the proviso that m+n>4, and m+n<12 where
the different monomers can be arranged in statistical order, alternatingly or as a block copolymer,
R⁴ is a methyl group,
where the concentration of the one or more fatty acid derivatives of the formula (Ia) is of from 0.01 to 99% by weight, based on the whole spray liquid.

14. An agrochemical composition which is a spray liquid comprising at least one agrochemical active ingredient, which is different from the fatty acid derivative of the formula (I), 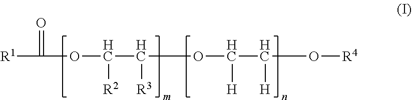
wherein
R¹ is an alkyl group containing 5 to 17 carbon atoms, which is linear or branched
R², R³ are, independently, hydrogen, methyl, ethyl or hydroxymethyl with the proviso that one of R² and R³ is hydrogen and the other is different from hydrogen
m, n are numbers from 0 to 17, with the proviso that m+n≥1, and m+n+p<18 where
the different monomers can be arranged in statistical order, alternatingly or as a block copolymer;
R⁴ is hydrogen or an alkyl group containing 1 to 10 carbon atoms, which is linear or branched,
and one or more fatty acid derivatives of the formula (Ia), 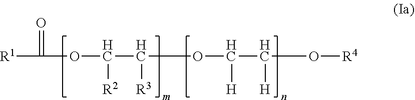
wherein
R¹ is an alkyl group containing 5 to 13 carbon atoms, which is linear or branched;
R², R³ are, independently, hydrogen, methyl, ethyl or hydroxymethyl;
m, n are numbers from 0 to 12, with the proviso that m+n>4, and m+n<12 where
the different monomers can be arranged in statistical order, alternatingly or as a block copolymer,
R⁴ is a methyl group,
where the concentration of the one or more fatty acid derivatives of the formula (Ia) is of from 0.0001 to 1% by weight, based on the whole spray liquid.

15. (canceled)
